(19) United States
(12) Patent Application Publication
(10) Pub. No.: US 2021/0061245 A1
(43) Pub. Date: Mar. 4, 2021

(54) Valve Cartridge for a Solenoid Valve

(71) Applicant: Robert Bosch GmbH, Stuttgart (DE)

(72) Inventors: Jens Norberg, Stuttgart (DE); Andreas Lechler, Moeglingen (DE); Patrick Schellnegger, Ludwigsburg (DE)

(21) Appl. No.: 16/942,027

(22) Filed: Jul. 29, 2020

(30) Foreign Application Priority Data
Aug. 30, 2019 (DE) 10 2019 213 147.6

(51) Int. Cl. B60T 8/36; F16K 31/06; F16K 27/02

(52) U.S. Cl. CPC B60T 8/363; F16K 31/0686; F16K 27/029; F16K 31/0662

(57) ABSTRACT

A valve cartridge for a solenoid valve, includes a capsule, a magnet armature which is guided in a movable manner within the capsule, a valve insert, and a valve body which has a main valve seat. The magnet armature, which is moved by a generated magnetic force, acts within the valve insert on a closing device, which has a plunger and a sealing element. The sealing element, in the currentlessly open state, opens up the main valve seat and, in the electrically energized, closed state, projects sealingly into the main valve seat of the valve body. The plunger and the sealing element are formed as separate components, and the sealing element is guided axially and/or radially by a guide device, which includes multiple guide balls arranged between the sealing element and an inner wall of the valve insert.

This application claims priority under 35 U.S.C. § 119 to application no. DE 10 2019 213 147.6, filed on Aug. 30, 2019 in Germany, the disclosure of which is incorporated herein by reference in its entirety.

The disclosure relates to a valve cartridge for a solenoid valve, in particular for a solenoid valve which is open in a currentless state.

### BACKGROUND

Known vehicle brake systems with ABS (antilock braking system) and/or ESP (electronic stability program) functionality comprise solenoid valves which are normally produced as ball-cone seat valves. Although this type of valve is inexpensive and meets high sealing requirements, the design exhibits a tendency to vibrate. The associated vibrations are transmitted in the form of pressure waves to the medium, or the brake fluid, flowing around. These pressure waves propagate in the hydraulic lines and cause the vehicle body to vibrate. In the vehicle interior compartment, the occupants perceive these audible vibrations, which is troublesome.

DE 102 24 430 A1 has disclosed a valve assembly which is in the form of a check valve and which consists of a housing with an entry opening and with an exit opening, in which housing an interior space is formed. The interior space has a valve seat on the entry side.

Moreover, in the interior space, an asymmetrical closing body on which a valve spring acting in the closing direction of the check valve acts and whose movement in the opening direction is limited by a stop is mounted in a movable manner. In this case, the resultant force acting on the closing body from the flow when the check valve is opened has a transverse component with respect to the opening direction.

Here, it may be considered to be a disadvantage that the action of the vibration suppression is dependent on flow speed and on fluid properties. Consequently, the action can be achieved only for particular temperature ranges and volume flows. A changeover to another fluid would result in a different behavior.

DE 10 2013 202 588 A1 has disclosed a valve assembly which consists of a valve housing in which a longitudinal channel connecting a valve inlet to a valve outlet is provided. A closing body is inserted into the longitudinal channel and is loaded by a closing spring in the direction of a valve seat formed in the valve housing. Provided in parallel with the closing body, for bypassing of the closing body, is preferably a hydraulic orifice. For damping vibrations of the closing body, an elastic friction element is arranged either upstream or downstream of the closing body in the valve housing, said friction element being received in a frictionally engaging manner between the valve housing and the closing body. The elastic friction element is preferably in the form of an O-ring.

Here, it may be considered to be a disadvantage that the action of the vibration suppression cannot be guaranteed over the lifetime of the vehicle. In this regard, wear reduces the lateral guidance, and changes in geometry of the elastic friction element owing to fluid absorption (swelling) have a negative effect on the opening behavior.

### SUMMARY

The valve cartridge for a solenoid valve having the features disclosed herein has the advantage that vibrations of the sealing element are able to be prevented, or at least reduced, by way of a defined axial and radial guidance of the sealing element. Moreover, the functionality can be maintained over the lifetime of the vehicle. Furthermore, embodiments of the valve assembly according to the disclosure are more inexpensive and easier to fit and also less dependent on the operating temperature.

Embodiments of the present disclosure provide a valve cartridge for a solenoid valve, having a capsule, having a magnet armature which is guided in a movable manner within the capsule, having a valve insert, and having a valve body which has a main valve seat. Here, the magnet armature, which is moved by a generated magnetic force, acts within the valve insert on a closing device, which has a plunger and a sealing element. The sealing element, in the currentlessly open state, opens up the main valve seat and, in the electrically energized, closed state, projects sealingly into the main valve seat of the valve body. Moreover, the plunger and the sealing element are formed as separate components, wherein the sealing element is guided axially and/or radially by a guide device, which comprises multiple guide balls which are arranged between the sealing element and an inner wall of the valve insert. Here, the guide balls may be arranged in the interior of the valve insert such that the guide balls are supported against one another in the circumferential direction. This means that the number of the balls is selected such that they are able to be supported against one another in the circumferential direction and non-uniform displacement of the balls can be prevented. In this way, it is possible to prevent for example a situation in which all the balls are situated only on one side of the closing body.

Due to the sealing element, which is guided by the guide balls, coaxiality errors or tolerances of the inner wall of the valve insert and of the main valve seat can be compensated. Consequently, the dimensional requirements for the components are lower, which leads to lower manufacturing costs overall. The effect of the compensation of radial play and the reduction in the tendency of the sealing element to vibrate can be established via the geometry of the sealing element and of the guide balls. Moreover, a hysteresis characteristic during the movement of the sealing element can be predefined by a friction force acting between the guide balls and the inner wall of the valve insert. In this case, the effective friction force can, for example, be predefined via the number and dimensions of the guide balls and the design of the inner wall of the valve insert and be matched to the respective application.

Embodiments of the valve cartridge according to the disclosure may preferably be used for solenoid valves which are open in a currentless state.

Advantageous improvements of the valve cartridge for a solenoid valve are possible by way of the measures and refinements detailed below.

It is particularly advantageous that the sealing element and/or the guide balls may preferably be in the form of metal balls, in particular steel balls. The design of the sealing element as a metal ball advantageously allows a higher degree of sealing in comparison with the prior art, since metal balls have a smaller shape deviation in comparison with injection-molded plungers and have a lower degree of wear in comparison with plastic materials.

In a further advantageous configuration of the valve cartridge, a force acting on the sealing element from the plunger can have a transverse component with respect to the axial closure component, such that the guide balls can be clamped at an angle to the sealing element and a resultant force on the sealing element can have an axially acting closure component and a transverse component acting perpendicular to the closure component.

In a further advantageous configuration of the valve cartridge, the guide device may comprise a compression spring, which, in the currentlessly open state, can generate a preload force, additional to a fluid force, which preload force can, via the guide balls, act on the sealing element and load the sealing element in the direction of the plunger. In this case, a guide cup which is guided in an axially movable manner may be arranged between the inner wall of the valve insert and the valve body, which guide cup may at least partially surround the compression spring. Moreover, a base of the guide cup may face the sealing element and have a central passage opening which the sealing element passes through in the closed state, wherein the guide balls bear against the base of the guide cup. Furthermore, a hysteresis characteristic during the opening process and/or closing process may be predefined by a friction force acting between the guide cup and the inner wall of the valve insert. Here, the effective friction force may, for example, be predefined via the design of the guide cup and/or of the inner wall of the valve insert and be matched to the respective application.

In a further advantageous configuration of the valve cartridge, the guide device may have at least one cutout, which may be formed in the valve body adjacent to the main valve seat and, in the closed state, at least partially receive the guide balls. In this case, the dimensions of the at least one cutout may preferably be selected such that the sealing projection of the sealing element into the main valve seat is made possible.

In a further advantageous configuration of the valve cartridge, the plunger may limit the opening movement of the sealing element. Alternatively, the guide device may have a stop means, which can limit the opening movement of the sealing element. The stop means may for example be in the form of a press-in sleeve. In order that the fluid can flow, it is possible to provide on the base of the press-in sleeve open flow cross sections, the shaping of which may be selected as desired. In this regard, the base of the press-in sleeve may have for example at least one passage and/or at least one cutout, which in each case form a flow cross section.

In a further advantageous configuration of the valve cartridge, the guide device may have an axially movable disk, which may be arranged between the sealing element and the plunger. In this case, the guide balls may be arranged between the disk and the sealing element. In order that the fluid can flow, it is possible to provide on the disk open flow cross sections, the shaping of which may be selected as desired. In this regard, the disk may have for example at least one passage and/or at least one cutout, which in each case form a flow cross section.

### BRIEF DESCRIPTION OF THE DRAWINGS

Exemplary embodiments of the disclosure are illustrated in the drawing and will be discussed in more detail in the following description. In the drawing, the same reference signs denote components or elements which perform identical or analogous functions.

FIG. 1 shows a schematic sectional illustration of a first exemplary embodiment of a valve cartridge according to the disclosure for a solenoid valve in the open state.

FIG. 2 shows a schematic sectional illustration of a second exemplary embodiment of a valve cartridge according to the disclosure for a solenoid valve in the open state.

FIG. 3 shows a schematic sectional illustration of a third exemplary embodiment of a valve cartridge according to the disclosure for a solenoid valve in the open state.

FIG. 4 shows a schematic sectional illustration of a fourth exemplary embodiment of a valve cartridge according to the disclosure for a solenoid valve in the open state.

### DETAILED DESCRIPTION

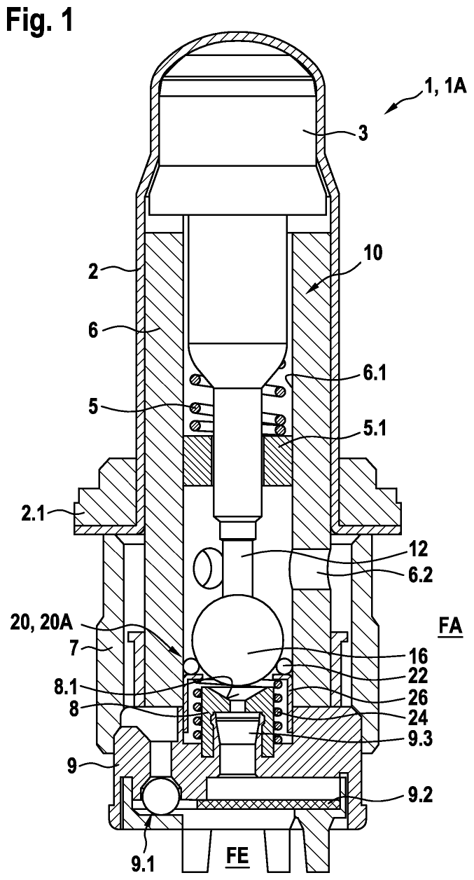

As can be seen from FIGS. 1 to 4, the illustrated exemplary embodiments of a valve cartridge 1, 1A, 1B, 1C, 1D according to the disclosure for a solenoid valve comprises in each case a capsule 2, a magnet armature 3 which is guided in a movable manner within the capsule 2, a valve insert 6, and a valve body 8 which has a main valve seat 8.1. The magnet armature 3, which is moved by a generated magnetic force, acts within the valve insert 6 on a closing device 10, which has a plunger 12 and a sealing element 16. Here, the sealing element 16, in the illustrated currentlessly open state, opens up the main valve seat 8.1 and, in the electrically energized, closed state, projects sealingly into the main valve seat 8.1 of the valve body 8. Moreover, the plunger 12 and the sealing element 16 are formed as separate components, wherein the sealing element 16 is guided axially and/or radially by a guide device 20, 20A, 20B, 20C, 20D, which comprises multiple guide balls 22 which are arranged between the sealing element 16 and an inner wall 6.1 of the valve insert 6.

In the illustrated exemplary embodiments of the valve cartridge 1, 1A, 1B, 1C, 1D, the sealing element 16 and the guide balls 22 are in each case in the form of metal balls. Moreover, a force acting on the sealing element 16 from the plunger 12 has a transverse component with respect to the axial closure component, such that the guide balls 12 are clamped at an angle to the sealing element 16 and a resultant force on the sealing element 16 has an axially acting closure component and a transverse component acting perpendicular to the closure component.

As can furthermore be seen from FIGS. 1 to 4, the valve insert 6 in the illustrated exemplary embodiments is inserted by way of a first end into the capsule 2. Moreover, the plunger 12 can be moved within the valve insert 6 by the magnet armature 3 counter to the force of a restoring spring 5, wherein the magnet armature 3 is moved by a magnetic force generated by a magnet assembly (not illustrated).

As can furthermore be seen from FIGS. 1 to 4, the capsule 2 can be calked via a calking bushing 2.1 at a calking region (not illustrated) in a receiving bore of a fluid block. The restoring spring 5 for the plunger 12 is arranged outside the flow region, wherein the restoring spring 5 is supported on a spring support 5.1, which, in the illustrated exemplary embodiment, is in the form of a clamping ring inserted into the valve insert 6. As a result of the relocation of the restoring spring 5 from the flowed-through structural space, the wear on the plunger 12 can be reduced and the throughflow between the main valve seat 8.1 and corresponding radial bores 6.2 formed in the valve insert 6 can be increased. In the illustrated open state of the exemplary embodiments, it is possible for there to be a fluid flow between an axial fluid inlet FE and a radial a fluid outlet FA via the open main valve seat 8.1.

As can furthermore be seen from FIGS. 1 to 4, the valve body 8 is in the form of a hood-like sleeve. The sleeve-like valve body 8 is formed for example as a deep-drawn part and can be inserted into a second end of the valve insert 6 such that the main valve seat 8.1 is arranged within the valve insert 6. As can furthermore be seen from FIGS. 1 to 4, a valve bottom part 9, in the form of a plastic insert, is placed and supported axially against the valve insert 6, wherein the valve bottom part 9 is sealingly inserted via a dome 9.3 into an interior space of the valve body 8 and, by way of the outer contour, provides sealing action with respect to the surrounding fluid block. Moreover, the illustrated valve bottom part 9 comprises an eccentrically arranged check valve 9.1, which performs a direction-oriented throughflow function. Additionally, the valve bottom part 9 accommodates a flat filter 9.2.

As can furthermore be seen from FIG. 1, the guide device 20A in the illustrated first exemplary embodiment of the valve cartridge 1A comprises a compression spring 24, which, in the currentlessly open state, generates a preload force, additional to a fluid force, which preload force, via the guide balls 22, acts on the sealing element 16 and loads the sealing element 16 in the direction of the plunger 12. The guide device 20A in the illustrated first exemplary embodiment moreover comprises a guide cup 26, which is guided in an axially movable manner between the inner wall 6.1 of the valve insert 6 and the valve body 8 and at least partially surrounds the compression spring 24. As can furthermore be seen from FIG. 1, a base of the guide cup 26 faces the sealing element 16 and has a central passage opening which the sealing element 16 passes through in the closed state. The guide balls 22 bear against the base of the guide cup 26. In the illustrated exemplary embodiment, a hysteresis characteristic during an opening process and/or closing process is predefined by a friction force acting between the guide cup 26 and the inner wall 6.1 of the valve insert 6.

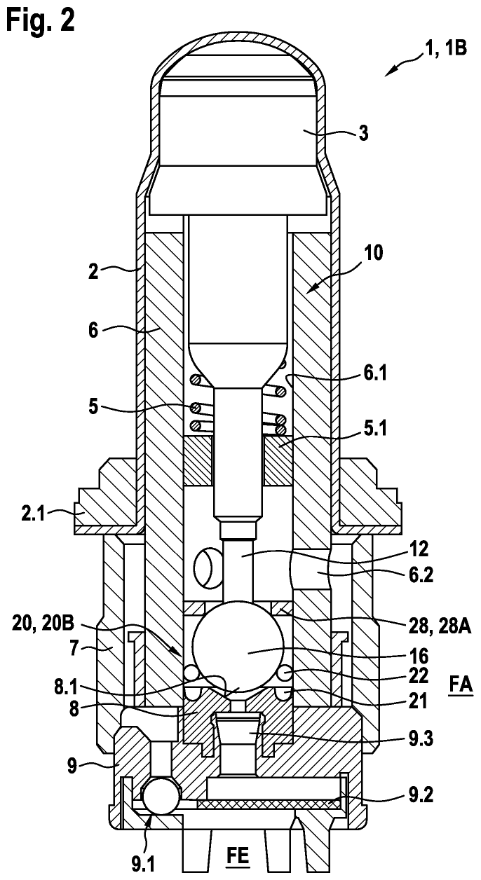

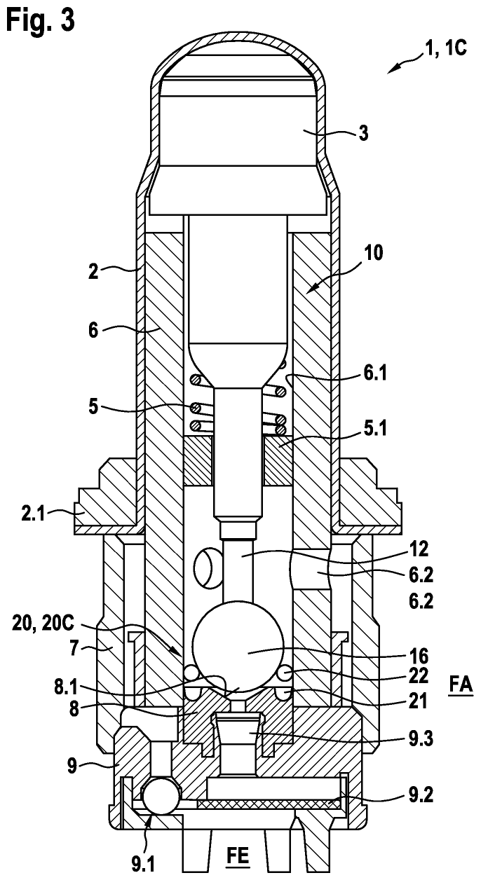

As can furthermore be seen from FIGS. 2 and 3, the guide device 20B, 20C in the illustrated exemplary embodiments of the valve cartridge 1B, 1C has at least one cutout 21, which, in the illustrated exemplary embodiment, is formed as an encircling annular groove in the valve body 8 adjacent to the main valve seat 8.1 and, in the closed state, at least partially receives the guide balls 22.

As can furthermore be seen from FIG. 2, the guide device 20B in the illustrated second exemplary embodiment of the valve cartridge 1B has a stop means 28, which limits the opening movement of the sealing element 16. In the illustrated second exemplary embodiment of the valve cartridge 1B, the stop means 28 is in the form of a press-in sleeve 28A.

As can furthermore be seen from FIG. 3, the guide device 20C in the illustrated third exemplary embodiment of the valve cartridge 1C does not have a stop means 28, with the result that the plunger 12 limits the opening movement of the sealing element 16.

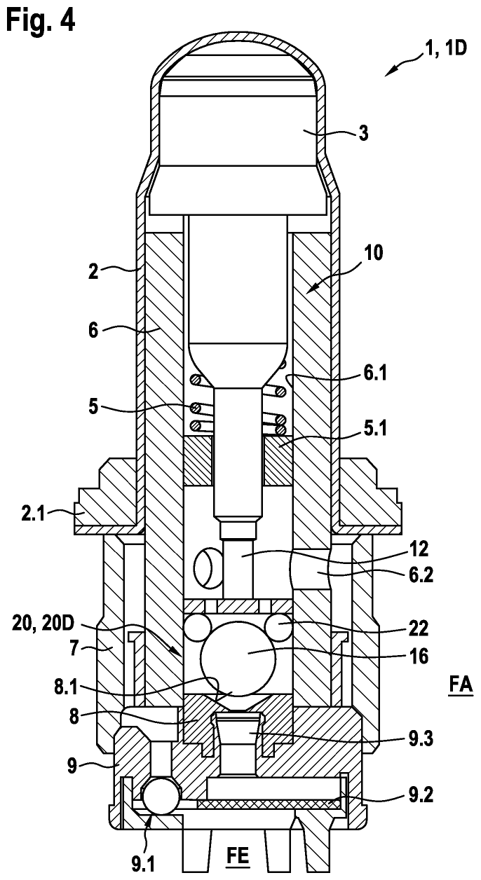

As can furthermore be seen from FIG. 4, the guide device 20D in the illustrated fourth exemplary embodiment of the valve cartridge 1D has an axially movable disk 23, which is arranged between the sealing element 16 and the plunger 12. In this case, the guide balls 22 are arranged between the disk 23 and the sealing element 16. Moreover, the axially movable disk 23 has at least one passage opening for the fluid flow. In the illustrated exemplary embodiment, multiple passage openings in the form of bores are formed in the disk. Alternatively, the at least one passage opening may be formed as a cutout at the edge of the disk.

1. A valve cartridge for a solenoid valve, comprising:
a capsule;
a magnet armature, which is guided in a movable manner within the capsule and is moved by a magnetic force;
a valve insert;
a valve body comprising a main valve seat;
a closing device acted on within the valve insert by the magnet armature, the closing device comprising:
a plunger; and
a sealing element configured to, in a currentlessly open state, open up the main valve seat and, in an electrically energized closed state, project sealingly into the main valve seat of the valve body, the plunger and the sealing element being formed as separate components; and
a guide device that guides the sealing element at least one of axially and radially, the guide device comprising multiple guide balls arranged between the sealing element and an inner wall of the valve insert.

2. The valve cartridge according to claim 1, wherein the sealing element and/or the guide balls are formed as metal balls.

3. The valve cartridge according to claim 1, wherein a force acting on the sealing element from the plunger has a transverse component with respect to an axial closure component such that the guide balls are clamped at an angle to the sealing element and a resultant force on the sealing element has an axially acting closure component and a transverse component acting perpendicular to the closure component.

4. The valve cartridge according to claim 1, wherein the guide device further comprises a compression spring, which, in the currentlessly open state, generates a preload force that supplements a fluid force, the preload force acting on the sealing element via the guide balls so as to load the sealing element in a direction toward the plunger.

5. The valve cartridge according to claim 4, wherein:
the guide device further comprises a guide cup, which is guided in an axially movable manner between the inner wall of the valve insert and the valve body and at least partially surrounds the compression spring,
a base of the guide cup faces the sealing element and has a central passage opening through which the sealing element passes in the closed state, and
the guide balls bear against the base of the guide cup.

6. The valve cartridge according to claim 5, wherein a hysteresis characteristic during an opening process and/or closing process is predefined by a friction force acting between the guide cup and the inner wall of the valve insert.

7. The valve cartridge according to claim 1, wherein the guide device includes at least one cutout defined in the valve body adjacent to the main valve seat, and, in the closed state, the at least one cutout at least partially receives the guide balls.

8. The valve cartridge according to claim 1, wherein the plunger limits an opening movement of the sealing element.

9. The valve cartridge according to claim 1, wherein the guide device further comprises a stop, which limits an opening movement of the sealing element.

10. The valve cartridge according to claim 9, wherein the stop includes a press-in sleeve.

11. The valve cartridge according to claim 1, wherein the guide device further comprises an axially movable disk arranged between the sealing element and the plunger, and the guide balls are arranged between the axially movable disk and the sealing element.
